(19) United States
(12) Patent Application Publication
(10) Pub. No.: US 2007/0019036 A1
(43) Pub. Date: Jan. 25, 2007

(54) Inkjet head and manufacturing method thereof

(75) Inventor: Haruhiko Deguchi, Tenri-shi (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/489,012

(22) Filed: Jul. 18, 2006

(30) Foreign Application Priority Data
Jul. 20, 2005 (JP) 2005-210524

(51) Int. Cl. B41J 2/04

(52) U.S. Cl. 347/54

(57) ABSTRACT

An inkjet head (1) includes: a substrate (2); a liquid passage section (3) formed on a surface of the substrate (2) to provide a passage for ink; and an eject section (5), which is a part of the liquid passage section (3), including an ejection opening (51) through which ink is ejected. At least the part of the eject section (5) which makes up the ejection opening (51) protrudes from an end of the substrate (2). Of the internal angles of a cross-section substantially perpendicular to a direction in which the protruding eject section (5) protrudes or a cross-section substantially parallel to the direction, all those internal angles, α to δ, which are formed by the external surfaces of the eject section (5) are greater than 20°.

This nonprovisional application claims priority under 35 U.S.C. § 119(a) on Patent Application No. 2005-210524 filed in Japan on Jul. 20, 2005, the entire contents of which are hereby incorporated by reference.

### FIELD OF THE INVENTION

The present invention relates to inkjet heads ejecting liquid to print a fine pattern of fine dots and manufacturing methods of such heads.

### BACKGROUND OF THE INVENTION

So-called “inkjet printers” are widely used now to print characters, images, etc. on sheets of various materials. The inkjet printer prints by spraying print paper with fine droplets of ink.

Recent applications of the inkjet printer technology are found in, among others, the forming of fine patterns on liquid crystal display color filters and conductor patterns on printed wiring boards. Conventionally, these patterns were formed by photolithography.

Active development programs are being implemented to apply the inkjet technology to, for example, fine dot forming devices which are able to form fine patterns with high accuracy by applying fine ink dots to a print target object (for example, a liquid crystal display color filter or a printed wiring board).

The fine dot forming device needs an inkjet head which ejects ink at a print target object in a stable manner and delivers ink dots to desired positions with high accuracy.

Incidentally, to apply fine ink dots to a print target object, the droplet of ink ejected from the inkjet head needs to be controlled so that it has as small a diameter as, for example, 10 μm or even less. However, as the droplet becomes smaller in size, the cross-sectional area of the droplet on which the droplet receives air resistance grows relative to the inertial mass of the droplet. Any ejection method that does not accelerate fluid floating in the air therefore has poor accuracy in the delivery of ink dots at desired positions.

Accordingly, to precisely deliver the above-mentioned fine ink dots onto a print target object, an inkjet scheme based on electrostatic absorption is used whereby electrostatic force is applied to the fluid floating in the air.

Inkjet technology based on electrostatic absorption is disclosed in Japanese Unexamined Patent Publication 9-156109/1997 (Tokukaihei 9-156109; published on Jun. 17, 1997) and Japanese Unexamined Patent Publication 2002-96474 (Tokukai 2002-96474; published on Apr. 2, 2002), for example.

To spray fluid to the print target object using the inkjet head of the electrostatic absorption scheme like the one above, there is needed an electric field highly concentrated at the fluid's meniscus formed at the tip of each nozzle of the inkjet head.

To effectively develop a high concentration of electric field at the meniscus, the nozzles suitably have a tubelike structure which is protruding as much as possible. To reduce the size of the ink droplets ejected at the print target object, the size of the openings of the nozzles is desirably as small as possible.

Fabricating a protruding, tubelike nozzle with a conventional inkjet head manufacturing method, however, results in small burrs being formed around the opening of the nozzle. The burrs alter the direction in which ink is ejected. An inkjet head with such nozzles exhibits seriously poor imaging quality.

### SUMMARY OF THE INVENTION

The present invention, conceived to address this problem, has an objective to provide an inkjet head capable of ejecting ink in a particular direction.

An inkjet head of the present invention, to address this problem, is characterized as follows: The inkjet head receives a liquid and ejects the liquid at a print target object in response to voltage application. The head includes: a substrate; and a hollow section formed on a surface of the substrate to provide a passage for the liquid. The hollow section includes an eject section with an ejection opening through which the liquid is ejected. At least a part of the eject section, which forms the ejection opening, protrudes from an end of the substrate. Of internal angles of a cross-section substantially perpendicular to a direction in which the eject section protrudes or a cross-section substantially parallel to the direction, all those internal angles which are formed by external surfaces of the eject section are greater than 20°.

According to the arrangement, the hollow section is formed on a surface of the substrate to provide a liquid passage. Therefore, the hollow section is easier to make than a hollow section built in the substrate.

At least a part the eject section, which forms the ejection opening, protrudes an end of a surface of the substrate. The protrusion allows an electric field to be readily concentrated at the tip of the eject section. The applied voltage can be reduced. The liquid can be ejected in a stable manner.

Some of the internal angles of a cross-section substantially perpendicular to a direction in which the eject section protrudes or a cross-section substantially parallel to the direction are formed by the external surfaces of the eject section; the others are formed by the internal surfaces of the eject section which surround the liquid passage. In the above arrangement, those formed by the external surfaces of the eject section are all greater than 20°. This indicates that there exist no sharp burrs 20° or smaller on the external surfaces of the eject section.

If there exists a sharp burr 20° or smaller on the external surfaces of the eject section, A Taylor cone (a film of liquid formed by the concentration of an electric field) develops around the burr. The generation of the Taylor cone increases the possibility of liquid droplets flying off a predetermined direction.

According to the arrangement, there are no sharp burrs 20° or smaller on the external surfaces of the eject section. The absence reduces the possibility of Taylor cones occurring at locations other than predetermined locations. In other words, the locations of Taylor cones occurring can be controlled in a stable manner.

The eject section thus ejects liquid droplets in a fixed direction. The locations of delivery of liquid droplets can be set out with high accuracy.

A method of manufacturing an inkjet head of the present invention, to address the problem, is characterized as follows: The method is directed at the manufacture of an inkjet head receiving a liquid and ejecting the liquid at a print target object in response to voltage application. The method includes the steps of: (a) fabricating a hollow section formed on a surface of a substrate to provide a passage for the liquid, the hollow section including an eject section with an ejection opening through which the liquid is ejected; (b) etching an end of the substrate so that at least a part of the eject section protrudes from the end; and (c) etching away a burr on an external surface of the eject section to remove the burr.

According to the arrangement, in step (a), a hollow section is formed on a surface of the substrate. The hollow section has a hollow structure which provides a liquid passage and includes an eject section with an ejection opening through which the liquid is ejected.

The hollow section, since disposed on a surface of the substrate, is easier to make than a hollow section built in the substrate.

In step (b), an end of the substrate is etched so that at least a part of the eject section with an ejection opening which has been formed on the etched substrate protrudes from the end.

The eject section, which forms the ejection opening, protrudes from an end of the substrate. The protrusion allows an electric field to be readily concentrated at the tip of the eject section (ejection opening). The applied voltage can be reduced. The liquid can be ejected in a stable manner.

Nevertheless, if there is a sharp-edged burr on an external surface of protruding eject sections, A Taylor cone may possibly grow around the burr. The generation of the Taylor cone increases the possibility of liquid droplets flying off a predetermined direction.

Accordingly, in step (c), the burr is removed by etching, which limits Taylor cone occurring at unwanted locations. The flying direction of liquid droplets is better controlled. Therefore, the location of delivery of liquid droplets can be set out with accuracy.

Therefore, unwanted burrs on the external surfaces of the eject sections are efficiently and readily removed. As a result, the inkjet head is readily manufactured with good ejection stability.

Additional objects, advantages and novel features of the invention will be set forth in part in the description which follows, and in part will become apparent to those skilled in the art upon examination of the following or may be learned by practice of the invention.

### BRIEF DESCRIPTION OF THE DRAWINGS

FIG. 1 is a cross-sectional view of an inkjet head shown in FIG. 2, taken along arrow A.

FIG. 2 is a perspective view illustrating the structure of the inkjet head of the present embodiment.

FIG. 3 is a cross-sectional view of the inkjet head shown in FIG. 2, taken along arrow B.

FIG. 4 is a cross-sectional view of the inkjet head shown in FIG. 2, taken along arrow C.

FIGS. 5(a) to 5(e) are cross-sectional views illustrating steps of fabricating a liquid passage section in the inkjet head of the present embodiment. FIG. 5(a) shows a step forming an insulating layer. FIG. 5(b) shows a step forming a lower passage layer. FIG. 5(c) shows a step forming a resist. FIG. 5(d) shows a step forming a base layer for an upper passage layer. FIG. 5(e) shows a step forming the upper passage layer.

FIG. 6 is a cross-sectional view of a reverse tapered liquid passage section which is a part of the inkjet head of the present embodiment.

FIGS. 7(a) to 7(d) are cross-sectional views illustrating steps of fabricating an inkjet head of the present embodiment. FIG. 7(a) shows a step forming an ejection opening. FIGS. 7(b) and 7(c) show a step etching a substrate's end face. FIG. 7(d) shows a step removing a resist.

FIG. 8 is a schematic illustrating an electrolysis etching method involved in a manufacturing step for the inkjet head of the present embodiment.

FIGS. 9(a) and 9(b) are cross-sectional views illustrating steps of fabricating an inkjet head of the present embodiment. FIG. 9(a) is a cross-sectional view showing a step attaching a manifold. FIG. 9(b) is a cross-sectional view showing a step attaching a circuit section.

FIGS. 10(a) to 10(c) are perspective views illustrating steps of fabricating a manifold in an inkjet head of the present embodiment. FIG. 10(a) shows a step forming grooves in a base member. FIG. 10(b) shows a step joining a glass substrate. FIG. 10(c) shows a step cutting the substrate into predetermined sizes.

FIG. 11 is a perspective view illustrating another shape of the eject section in an inkjet head of the present embodiment.

FIG. 12 is a perspective view illustrating a yet another shape of the eject section in the inkjet head of the present embodiment.

FIGS. 13(a) and 13(b) illustrate other steps of fabricating an eject section in an inkjet head of the present embodiment. FIG. 13(a) is a plan view illustrating a step laminating the eject section with a resist and the shape of the eject section after etching. FIG. 13(b) is a cross-sectional view illustrating a step laminating the eject section with a resist and the shape of the eject section after etching and removing the resist.

FIGS. 14(a) and 14(b) illustrate yet other steps of fabricating an eject section in an inkjet head of the present embodiment. FIG. 14(a) is a plan view illustrating a step laminating the eject section with a resist and the shape of the eject section after etching. FIG. 14(b) is a cross-sectional view illustrating a step laminating the eject section with a resist and the shape of the eject section after etching and removing the resist.

FIG. 15 is a perspective view illustrating the structure of an inkjet head for a comparative example.

FIGS. 16(a) to 16(c) are cross-sectional views illustrating the structure and method of manufacturing of a liquid passage section in an inkjet head for a comparative example. FIG. 16(a) shows an upper passage layer and a lower passage layer being manufactured. FIG. 16(b) shows the base layer having been removed. FIG. 16(c) shows variations of the upper passage layer and the lower passage layer.

FIGS. 17(a) to 17(c) are cross-sectional views illustrating an etching process performed on a tip of the eject section in an inkjet head for a comparative example. FIG. 17(a) shows a step laminating the eject section with a mask material. FIG. 17(b) shows an etching step on the eject section. FIG. 17(c) shows a step removing the resist.

FIGS. 18(a) and 18(b) are cross-sectional views of ejection of ink from an inkjet head for a comparative example. FIG. 18(a) is a cross-sectional view taken perpendicular to the length of the eject section. FIG. 18(b) is a cross-sectional view taken parallel to the length of the eject section.

### DESCRIPTION OF THE EMBODIMENTS

[Comparative Example]

Before discussing the inkjet head of the present invention, we will first describe, as a comparative example, an inkjet head which we fabricated during the course of development of the inkjet head of the present invention.

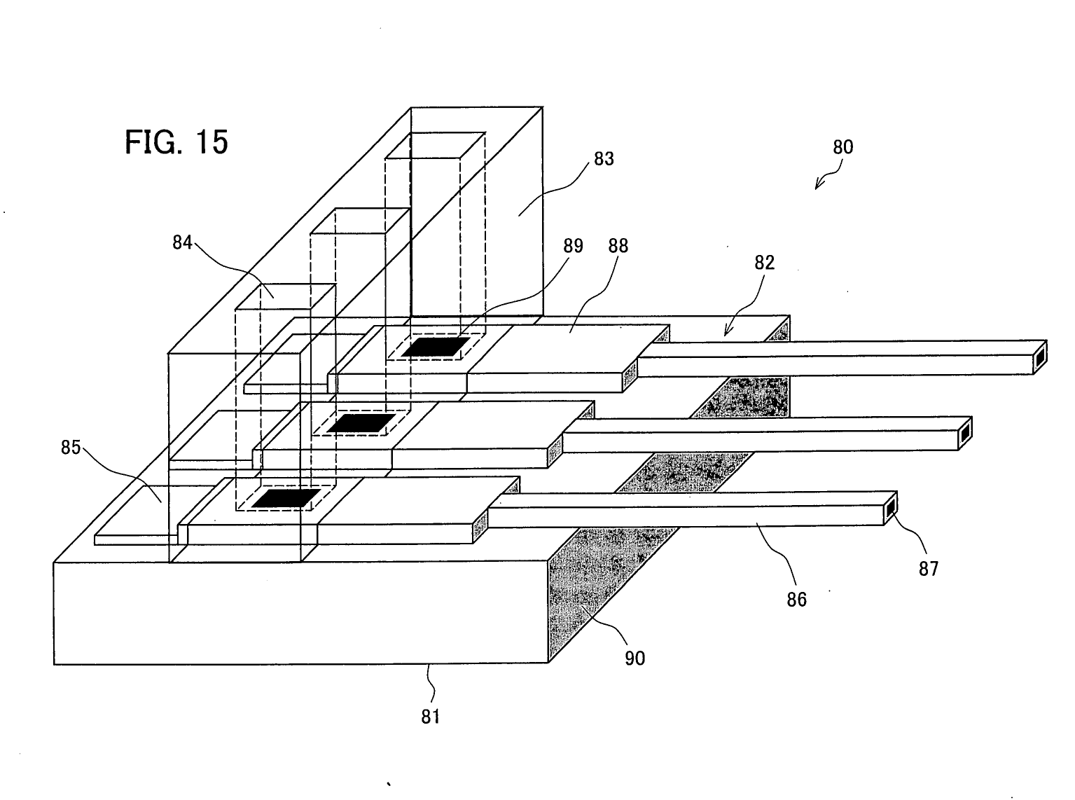

The following will describe a comparative example of the present invention in reference to FIGS. 15 to 18(b).

In the present comparative example, an inkjet head 80 which ejects fine ink dots will be described. FIG. 15 is a perspective view illustrating the structure of the inkjet head 80 of the present comparative example. As shown in the figure, the inkjet head 80 includes a substrate 81, liquid passage sections 82, a manifold 83, and circuit sections 85.

The substrate 81 is made of silicon having such a crystal lattice that the substrate's face has the Miller indices of (100).

The liquid passage section 82 provides a channel through which ink flows before being sprayed at the print target object. Each liquid passage section 82 has in it a through hole, allowing the ink to pass inside the liquid passage section 82. The inkjet head 80 has three liquid passage sections 82 on a surface of the substrate 81 with 169 μm intervals.

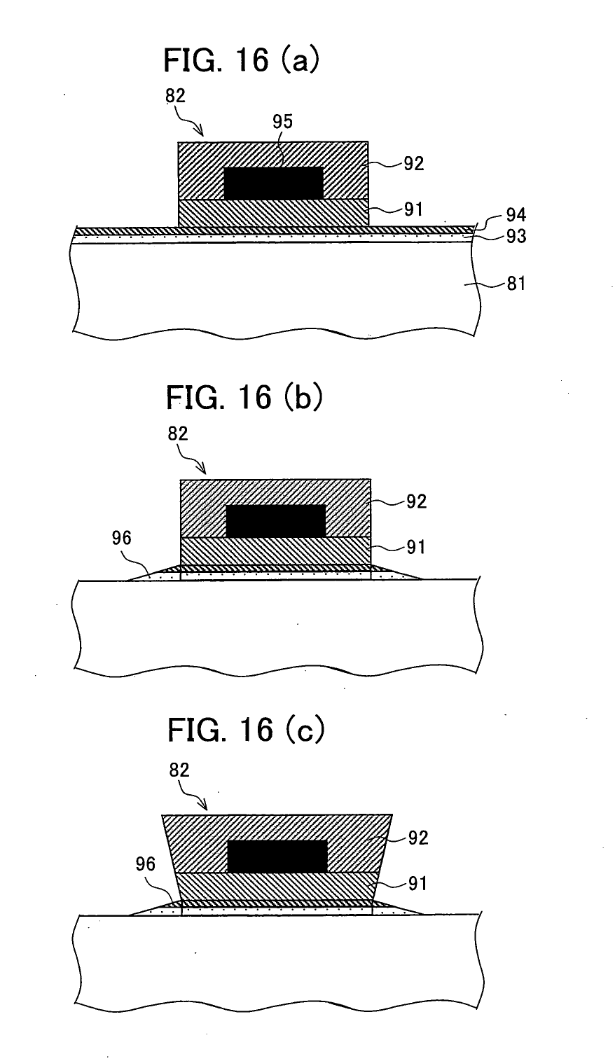

FIGS. 16(a) to 16(c) are cross-sectional views illustrating the structure and method of manufacturing of the liquid passage section 82. As shown in FIG. 16(a), the liquid passage section 82 includes a lower passage layer 91 and an upper passage layer 92. The lower passage layer 91 and the upper passage layer 92 are 2-μm thick electrical conductors, chiefly Ni.

Referring back to FIG. 15, the liquid passage section 82 has a supply section 88 and an eject section 86 at its respective ends. The supply section 88 has a liquid supply port 89 through which is supplied the ink which will be ejected at the print target object. The eject section 86 has an ejection opening 87 from which the ink is ejected at the print target object. The eject section 86 is partly protruding beyond an end face 90 of the substrate 81 on which the liquid passage section 82 is provided.

The manifold 83 supplies ink to the individual liquid passage sections 82 and is composed of insulating material. The manifold 83 covers the liquid passage sections 82, and on an end face, is disposed on a surface of the substrate 81 so as to come in contact with the substrate 81.

The manifold 83 has in it as many fluid supply holes 84 as the liquid passage sections 82. Each fluid supply hole 84 is disposed to correspond to an associated one of the liquid supply ports 89.

The circuit section 85 is fed with an eject signal with which to control ink ejection at the print target object. The section 85 is electrically connected to external signal transmission means (not shown), such as a flexible substrate, by wire bonding or other bonding technology.

Method of Fabricating Liquid Passage Sections 82

Now, a method of fabricating the liquid passage sections 82 will be described in reference to FIGS. 16(a) and 16(b).

As shown in FIG. 16(a), first, a base layer 94 which is an underlayer for the lower passage layer 91 is deposited on the surface of the substrate 81 with an insulating layer 93 being interposed. After that, the lower passage layer 91 is formed by depositing Ni to a thickness of 0.5 to 4 μm by selective plating.

Next, a photoresist is deposited to a thickness of 0.5 to 5 μm on lower passage layer 91 to form a liquid passage layer 95. After that, a base layer (Ni-containing film; not shown) for the upper passage layer 92 is formed, and the upper passage layer 92 is formed by Ni plating.

Thereafter, as shown in FIG. 16(b), excess parts of the base layer 94 for the lower passage layer 91 and the base layer for the upper passage layer 92 are removed by etching.

The insulating layer 93 is removed from the tip of the eject section 86 and its underlayer by dry etching in Ar or CF₄ gas to form the ejection opening 87. These last steps will be detailed later.

Problems in Method of Fabricating Liquid Passage Section 82

The following will describe problems in the aforementioned fabrication method for the liquid passage section 82 in reference to FIGS. 16(a) to 16(c).

As shown in FIG. 16(a), the upper passage layer 92 and the lower passage layer 91 are provided on their base layers. To prevent structural damage of the inkjet head due to separation of the upper passage layer 92 and the lower passage layer 91, it is preferable to remove excess parts of the base layers by dry etching.

The excess parts of the base layers are however not completely removed because of shadowing effects of the upper passage layer 92 and the lower passage layer 91 as shown in FIG. 16(b). There remain excess base layers (residues 96) in close proximity of the lower passage layer 91.

The selective plating using a resist or like mask material, whereby the upper passage layer 92 and the lower passage layer 91 are formed only in restricted, predetermined areas, provides the eject section 86 with a cross-section which looks like a trapezoid turned upside down or which shows “reverse tapered” side walls. See FIG. 16(c). With such a cross-sectional shape, there will likely be more residues 96 from the base layers.

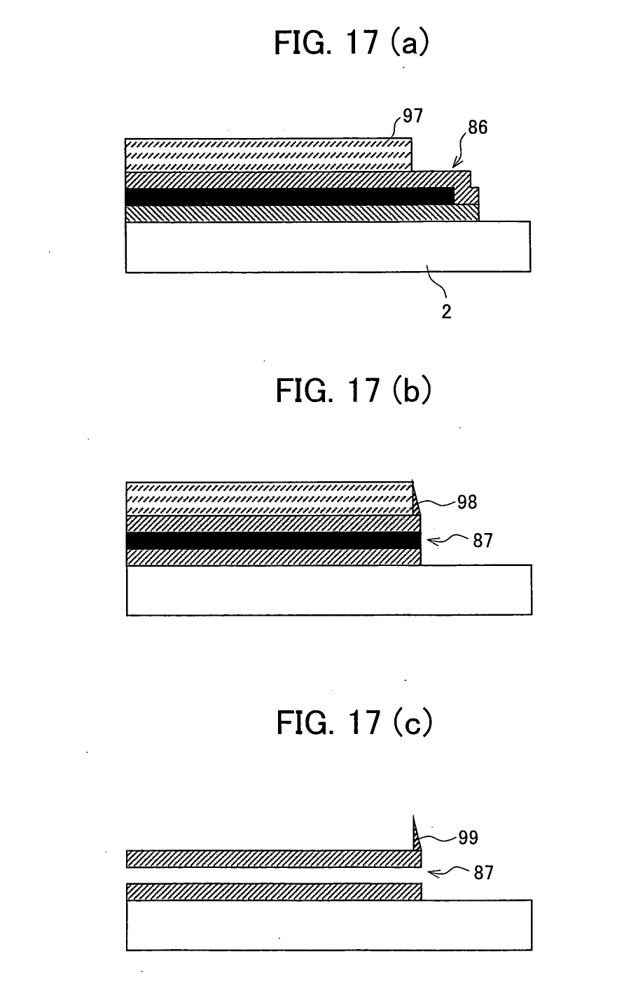

Next, we will describe problems in etching the tip of the eject section 86 in reference to FIGS. 17(a) to 17(c). FIGS. 17(a) to 17(c) are cross-sectional views illustrating an etching process performed on a tip of the eject section 86. In the figures, no base layers are shown for convenience.

Referring to FIG. 17(a), the position of the tip of the eject section 86 is defined with a photoresist or like mask material 97. The eject section 86 is dry etched to form the ejection opening 87.

Dry etching of the Ni film made by plating as above leaves part of the etched object (Ni film) being deposited again as a re-deposit 98 on the side faces of, for example, the photoresist as shown in FIG. 17(b). Following the etching process, if the photoresist or other mask material is removed using a solvent, for example, acetone, the re-deposit 98 remains on the processed end of the eject. section 86, shaped like a “horn” as shown in FIG. 17(c).

As explained above, the inkjet head 80 has the residues 96 or the horn-like re-deposits 99 on the side faces of the eject sections 86 and over the ejection openings 87.

Problems with Inkjet Head 80

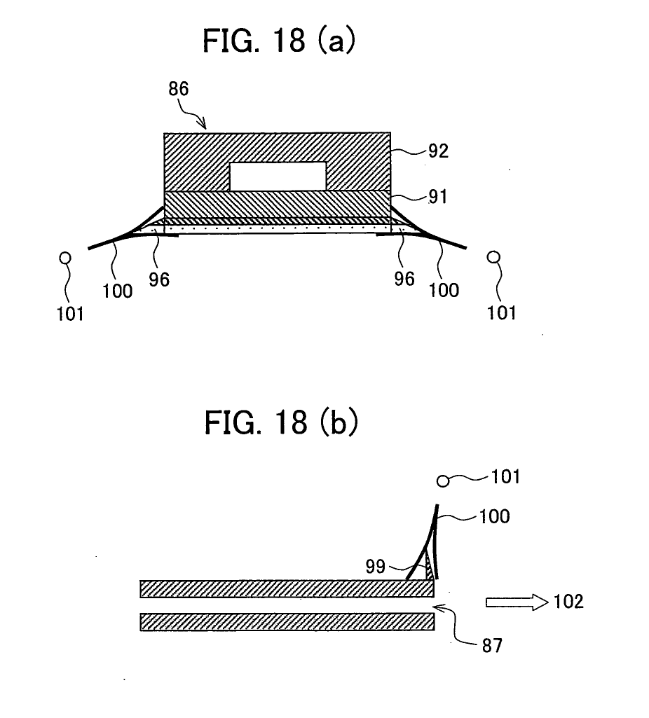

The following will describe how ink is ejected when an eject signal is sent to the inkjet head 80 in reference to FIGS. 18(a) and 18(b) which are cross-sectional views showing ink ejection from the inkjet head 80.

FIG. 18(a) is a cross-sectional view taken perpendicular to the length of the eject section 86. As shown in the figure, there are non-uniform residues 96 being formed on the side faces of the lower passage layer 91. The apex of the residue 96 is about 10°, rendering the residue 96 a sharp burr.

Filling the inkjet head 80 having the residue 96 with ink and applying ejection voltage causes a Taylor cone (liquid ink film formed under a local intense electric field) 100 to grow from the residue 96 near the ejection opening 87. A liquid droplet 101, which in the absence of the Taylor cone would fly in the direction in which the eject section 86 extends, is deflected toward the residue 96.

The residues 96 are not formed in a stable manner even with process control. They grow at varying positions and in inconsistent shapes. The Taylor cones 100 hence grow at varying positions and extend in varying directions. It is impossible to predict in which direction the liquid droplets 101 will fly.

In a “multi-nozzle head” equipped with a plurality of nozzles like the inkjet head 80, different nozzles may eject liquid droplets in different directions, seriously affecting the image quality on the medium.

FIG. 18(b) is a cross-sectional view taken parallel to the length of the eject section 86 near the ejection opening 87. As shown in the figure, there is a horn-like re-deposit 99 formed over the ejection openings 87 when the ejection opening 87 was made. The apex of the horn-like re-deposit 99 is about 10°., rendering the horn-like re-deposit 99 a sharp burr.

Filling the inkjet head 80 having the horn-like re-deposit 99 with ink and applying ejection voltage causes a Taylor cone 100 to grow from the horn-like re-deposit 99. A liquid droplet 101 is deflected toward the horn-like re-deposit 99, failing to fly in the direction in which the eject section 86 extends (indicated by arrow 102 in the figure).

The horn-like re-deposits 99 are not formed in a stable manner even with process control. They grow at varying positions and in inconsistent shapes. The Taylor cones 100 hence grow at varying positions and extend in varying directions. It is impossible to predict in which direction the liquid droplet 101 will fly.

In a “multi-nozzle head” equipped with a plurality of nozzles like the inkjet head 80, different nozzles may eject liquid droplets in different directions, seriously affecting the image quality on the medium.

As described in the foregoing, in the inkjet head 80, the residues 96 and the horn-like re-deposit 99 non-uniformly alter the direction in which liquid droplets are ejected. Therefore, liquid droplets from different nozzles fly in different directions, seriously degrading image quality.

Embodiment 1

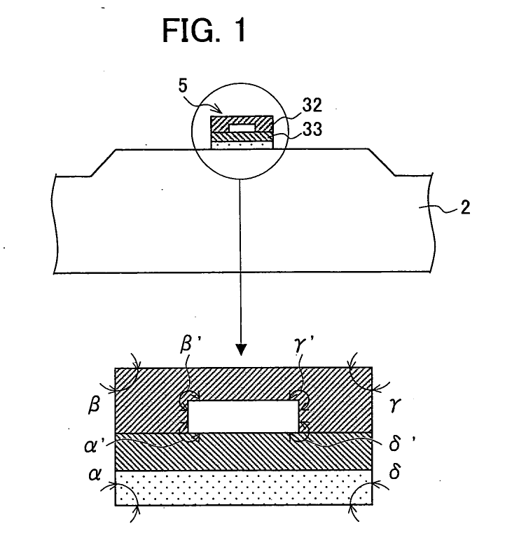

The following will describe an embodiment of the present invention in reference to FIGS. 1 to 14(b).

Inkjet Head Structure

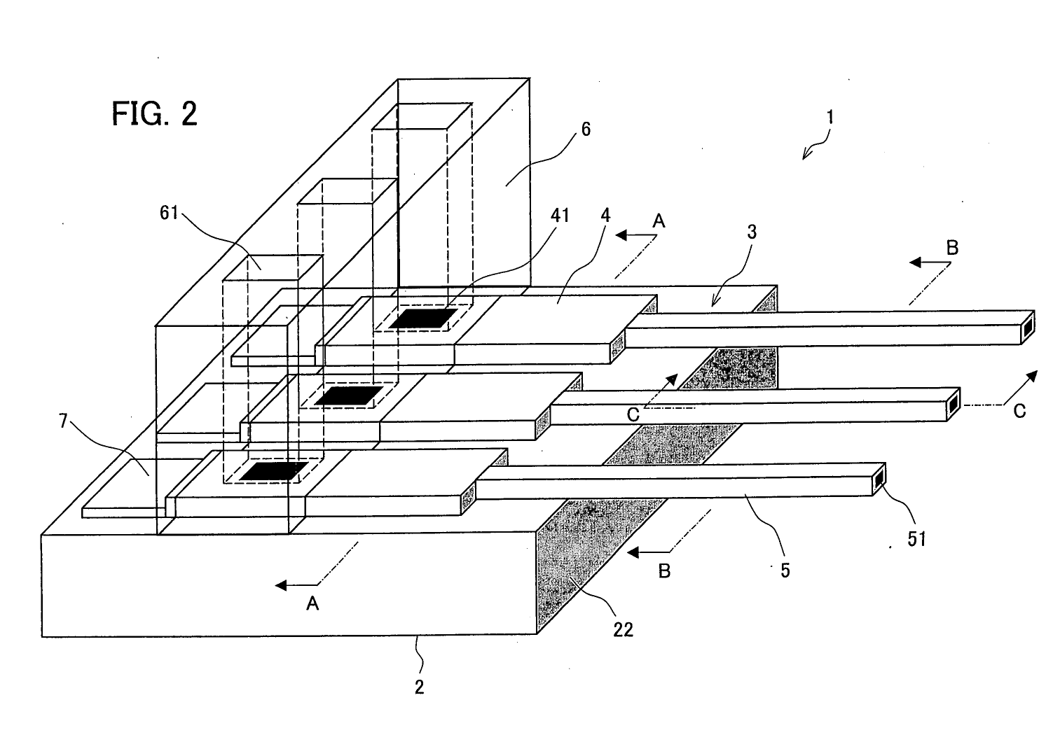

First will be described the structure of an inkjet head 1 in accordance with the present embodiment in reference FIGS. 1 and 2. FIG. 2 is a schematic perspective view illustrating the structure of the inkjet head 1.

The inkjet head 1 of the present embodiment ejects fine liquid droplets at a print target object. The following description will deal with ink as an example of the liquid from which the droplets are made. The liquid is not limited to ink and could be any liquid whose droplets can be ejected from the inkjet head 1. Viscosity is not limited in any particular manner.

The inkjet head 1 is of an “electrostatic ejection type” which applies an electric field to ink so that the ink is ejected by an electrostatic repulsive force at the print target object. The inkjet head 1, when voltage is applied, generates an electric field concentrated in proximity of ejection openings 51 of liquid passage sections 3 on the inkjet head 1 and ejects droplets of ink at the print target object.

The inkjet head 1 is a part of a fine dot forming device (not shown) which forms a fine pattern of fine dots on a print target object (for example, a liquid crystal display color filter or a printed wiring board). The inkjet head 1 is constructed as follows.

The inkjet head 1, as shown in FIG. 2, includes a substrate 2, liquid passage sections 3, a manifold 6, and circuit sections 7.

The substrate 2 is a member providing a base for the liquid passage sections 3 and made of monocrystal silicon. The surface of the substrate 2 which supports the liquid passage sections 3 is a face of a crystal lattice with Miller indices of (100).

The liquid passage section (hollow section) 3 provides a channel through which ink flows before being sprayed at the print target object. Each liquid passage section 3 has a through hole, allowing the ink to pass inside the liquid passage section 3. The inkjet head 1 has three liquid passage sections 3 on the surface of the substrate 2 with 169 μm intervals. The liquid passage section 3 has at its respective ends an supply section 4 which supplies ink and an eject section 5 which ejects the ink at the print target object.

The supply section 4 has a liquid supply port 41, or a hole through which ink is supplied to the liquid passage section 3. The liquid supply ports 41 of the liquid passage sections 3 are positioned on a single line.

The eject section 5 extends from the supply section 4. At the tip of the section 5 is provided the ejection opening 51 from which ink is ejected. The eject section 5 is partly protruding beyond an end face 22 of the substrate 2. In the present embodiment, the part of the eject section 5 which extends beyond the end face 22 of the substrate 2 is 50 μm or longer (protrusion length).

The liquid passage section 3 has such a width that it is narrower at the eject section 5 than at the supply section 4. The liquid passage section 3 has a substantially consistent internal height at 0.5 to 5 μm. The section 3 however has an internal width of 0.5 to 6 μm near the ejection opening 51 and 50 to 100 μm near the liquid supply port 41. Hence, the section 3 has different cross-sectional areas near the ejection opening 51 and near the liquid supply port 41.

The overall size of the eject section 5 is 50 μm or longer, 2 to 10 μm wide, and 2 to 10 μm high. The ejection opening 51 is substantially a rectangle 0.5 to 6 μm wide and 0.5 to 5 μm high.

The length above is measured in the direction in which liquid flows in the liquid passage section 3 from the supply section 4 to the ejection opening 51 (longitudinal direction of the liquid passage section 3). The height above is measured perpendicular to the surface of the substrate 2 on which the liquid passage section 3 is provided. The width above is measured perpendicular to the direction, in the surface of the substrate 2, from the supply section 4 to the ejection opening 51.

The manifold 6 supplies ink to the supply sections 4 and is made of an insulating material. The manifold 6, as shown in FIG. 2, is placed on top of the substrate 2 so as to cover the liquid supply ports 41 of the liquid passage sections 3 on the substrate 2.

The manifold 6 has in it as many fluid supply holes 61 as the supply sections 4. The manifold 6 is joined on an end face with each supply section 4 so that the fluid supply hole 61 communicates with the liquid supply port 41. The fluid supply hole 61, where it connects to the contact section, is preferably larger in size than the liquid supply port 41.

The fluid supply holes 61 of the manifold 6 are joined, opposite the supply sections 4, with a common liquid chamber (not shown). Liquid is supplied from the common liquid chamber to all the fluid supply holes 61.

The circuit section 7 is fed with an eject signal with which to control ink ejection at the print target object. The circuit section 7 is located on an end face of the supply section 4 opposite the eject section 5. The section 7 is a part of the liquid passage section 3.

The circuit section 7 is electrically connected to external signal transmission means (not shown), such as a flexible substrate, by wire bonding or other bonding technology.

The circuit section 7 may be fabricated from either a lower passage layer 32 or an upper passage layer 33 (detailed later). In other words, it is sufficient if the circuit section 7 is electrically connected to at least the lower passage layer 32 or the upper passage layer 33 which are conductors.

Structure of Liquid Passage Section 3

Now, the structure of the liquid passage section 3 will be described in reference to FIGS. 1, 3, 4.

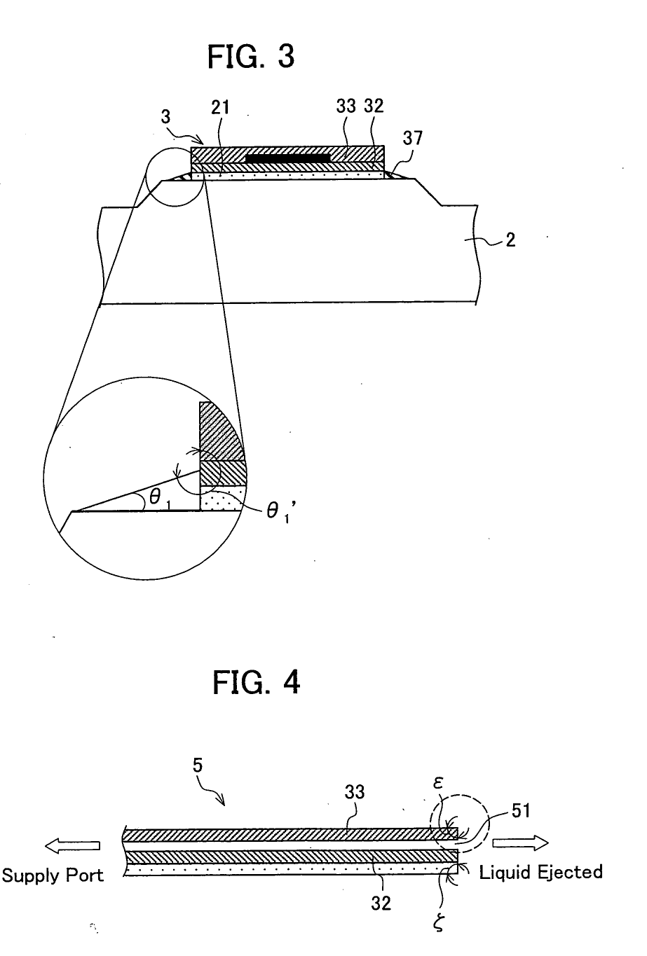

FIG. 1 is a cross-sectional view of the eject section 5 shown in FIG. 2, taken along arrow B. FIG. 3 is a cross-sectional view of the liquid passage section 3 (supply section 4) shown in FIG. 2, taken along arrow A.

The liquid passage section 3 is a hollow member providing an ink passage. The section 3 is fabricated stacking a plurality of layer on the substrate. Specifically, a layer which is removable by a particular technique is encased in hardly removable layers. The removable layer is then removed, leaving the hollow structure behind.

Any number of layers can be used. Considering the objective that there should be formed a hollow structure, it is sufficient if a single removable layer is encased in two hardly removable layers. By stacking at least these threes layers and removing the removable layer, a liquid passage section 3 with two layers can be fabricated.

Accordingly, the liquid passage section 3 of the present embodiment is primarily made of the lower passage layer 32 and the upper passage layer 33 as shown in FIG. 3.

The lower passage layer 32 and the upper passage layer 33 are 0.5- to 4-μm thick electrical conductors, chiefly Ni. Thus, electrically conducting layers are established from the circuit section 7 to the ejection opening 51. Electric charges, when supplied from the circuit section 7 to the ejection opening 51, meet less electrical resistance. The result is quick charging of the ink to be ejected, hence better response in ejection.

At least the lower passage layer 32 or the upper passage layer 33 needs be made of Ni. It is however preferable if both the layers 32, 33 are made of Ni to prevent erosion in etching solution in the etching of the substrate 2 (detailed later).

Where the liquid passage section 3 joins the substrate 2, an insulating layer 21 is provided. The layer 21 is, for example, a film of silicon oxide or silicon nitride 0.2 to 2 μm thick.

There are residues 37, sticking to the corners formed by the side walls of the liquid passage section 3 and the substrate 2, which are left over from a base removal process (detailed later). The residue 37 has an apex, θ1, of 10°, forming a sharp burr. In a case like this, angle θ1′, which is adjacent to the apex θ1, is greater than or equal to 180°. Angle θ1′ is defined as the angle made inside the residue 37 and the liquid passage section 3 by the oblique face of the residue 37 and the side face of the liquid passage section 3.

In contrast, referring to FIG. 3 showing a cross-section of the eject section 5 taken along arrow B, the etching (detailed later) has removed the residues 37 which are observed in the cross-section taken along arrow A. Therefore, as shown in the figure, the internal angles, α to δ, on the four corners of the rectangular cross-section which are formed by the external surfaces of the eject section 5 are all substantially 90°.

Ejection experiments demonstrate that burrs with an internal angle less than or equal to 20° will highly likely be growing points for undesirable Taylor cones. To put it in a different way, if the internal angle is greater than 20°, the burr will unlikely be a growing point for a non-uniform Taylor cone under an electric field, permitting the ink to be ejected in a desirable direction as designed. If the internal angle is in excess of 60°, the risk of the burr acting as a growing point for a non-uniform Taylor cone is more reliably reduced.

Therefore, the internal angle is not necessarily substantially 90°. Any angle greater than 20° is acceptable. If the eject section 5 has internal angles substantially 90°, undesirable Taylor cones are unlikely to grow on the external surfaces of the eject section 5.

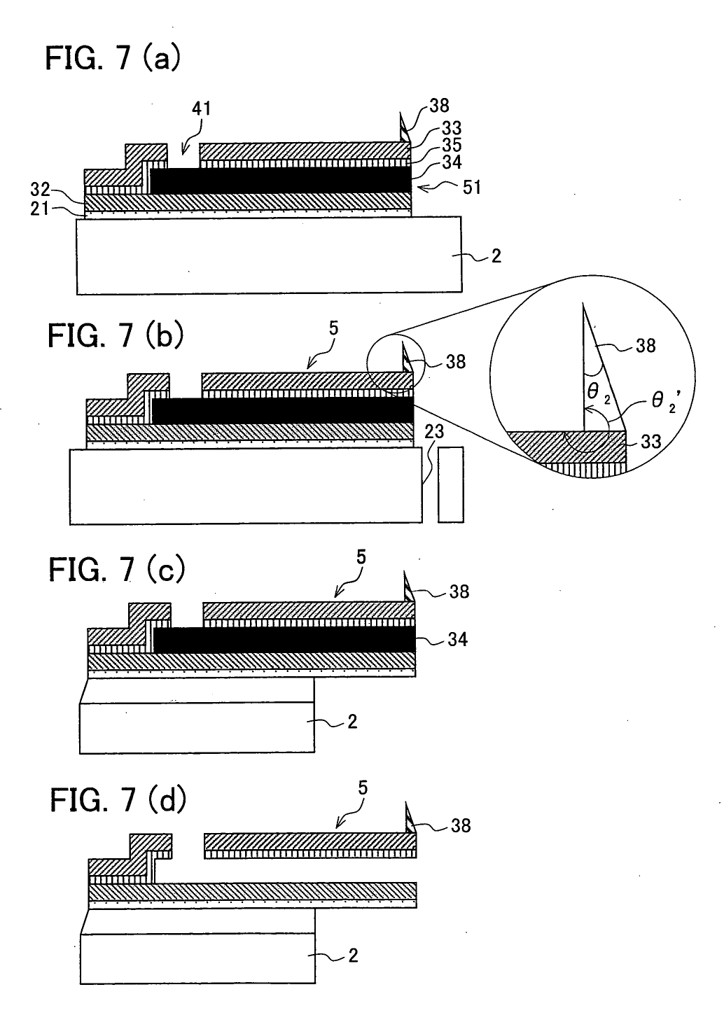

If residues 37 or horn-like re-deposits 38 (detailed later; see FIG. 7) grow, the residues 37 and the re-deposits 38 have internal angles of 20° or smaller. The residues 37 and the re-deposits 38 will likely be growing points for non-uniform Taylor cones.

As shown in FIG. 1, apart from the internal angles, α to δ, formed by the external surfaces of the eject section 5, the cross-section of the protruding eject section 5 taken substantially perpendicular to the protrusion direction has other internal angles, α to δ, formed by the internal surfaces of the eject section 5 enclosing the ink passage. The magnitude of the latter set of internal angles is not a cause for the undesirable Taylor cones.

The inkjet head 1 of the present embodiment ejects ink from the very tip of the nozzle. Thus, there are preferably no residues 37 (the internal angles formed by the external surfaces are substantially 90°) on the distal part of the eject section 5, at least 10 μm, preferably, 50 μm, the most preferably, 100 μm from its tip (ejection opening 51).

FIG. 4 is a cross-sectional view of the eject section 5 shown in FIG. 2, taken along arrow C. As shown in the figure, the tip of the eject section 5, encircled by broken lines, where the ejection opening 51 is formed, has no horn-like re-deposits being left over from the fabrication process of the ejection opening 51.

Accordingly, of the internal angles of the aforementioned cross-section, those which are formed by the external surfaces of the eject section 5 (ε, ζ) are substantially 90°. This reduces the possibility of undesirable Taylor cones growing around the ejection opening 51.

As described in the foregoing, the inkjet head 1 of the present embodiment is free from residues at least on the distal part of the eject section 5 (10 μm from the tip). Therefore, the growing positions of Taylor cones are controlled in a stable manner. Furthermore, the inkjet head 1 is free from horn-like re-deposits which would conventionally be formed due to re-deposition in the etching process of the tip of the eject section 5. Therefore, the growing positions of the Taylor cones are controlled in a stable manner. The nozzles hence have uniform eject directions. For these reasons, the inkjet head 1 is able to draw high quality images.

Method of Manufacturing Inkjet Head 1 Steps to Fabricate Liquid Passage Sections 3

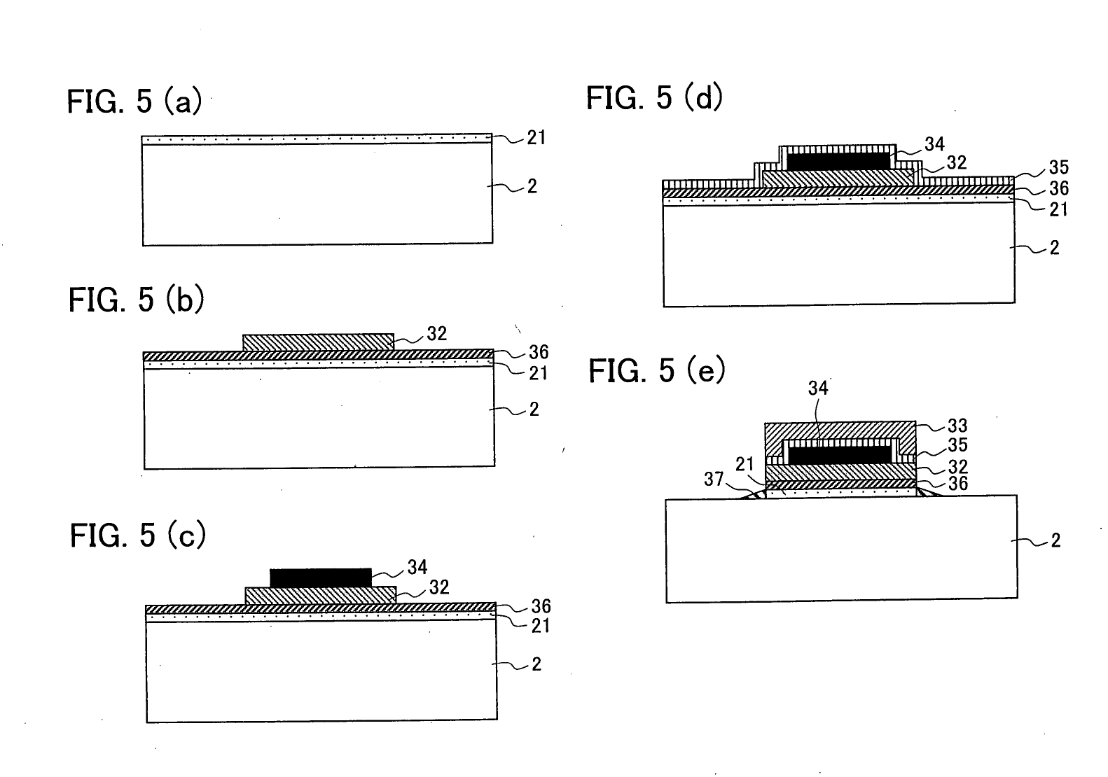

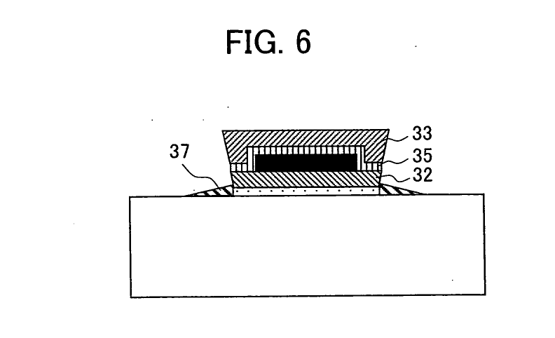

Next, a manufacturing method of the inkjet head 1 will be described. First, fabrication steps for the liquid passage section 3 will be described in reference to FIGS. 5(a) to 5(e) and 6. FIGS. 5(a) to 5(e) are cross-sectional views of the liquid passage section 3, taken along arrow A, showing fabrication steps for the liquid passage section 3.

First, an insulating layer 21 is formed on the substrate 2 of (100) monocrystal silicon. See FIG. 5(a). In this fabrication step for the insulating layer 21, a silicon oxide film is formed to a thickness of 0.2 μm to 5 μm as the insulating layer 21 by ordinary thermal oxidation.

The thickness of the insulating layer 21 is preferably set to a sufficient value to ensure isolation of the liquid passage section 3 which will be provided on the insulating layer 21 from the substrate 2. However, if the thickness is set to too large a value, the manufacturing process of the inkjet head 1 unnecessarily takes too much time. The thickness of the insulating layer 21 is preferably 0.2 μm to 5 μm.

Next, a base layer 36 is formed on the insulating layer 21, and a lower passage layer 32 is formed on it. See FIG. 5(b). The lower passage layer 32 is formed by plating with metallic material, chiefly Ni. To describe it in more detail, the insulating layer 21 is plated with the Ni film with two base films of Ta (50 nm) and Ni (50 nm), or the base layer 36, intervening between them.

The base layer 36 is a stack of a Ta film as an adhesive layer and a Ni film as a plating seed layer. The base layer 36 is desirably formed by sputtering whereby the resultant base film shows good adhesion. It is also desirable if the Ta and Ni films are stacked in this order without being exposed to atmosphere.

Next, the lower passage layer 32 is formed to a thickness of 0.5 to 4 μm by selective plating whereby the regions to be plated are restricted in advance using resist or like material. The base layer 36 of the lower passage layer 32 is however removed by dry etching in Ar after the formation of the lower passage layer 32. Since the base layer 36 is as thin as 100 nm, the pattern of the lower passage layer 32 can be used as a mask in etching. No separate mask needs to be made from, for example, photoresist. As mentioned earlier, the base layer 36 partly remains as residues along the pattern of the lower passage layer 32 because of shadowing effects of the pattern of the lower passage layer 32.

In prior art, the base layer 36 was removed by wet etching. An investigation by the inventors however has revealed that in wet etching, the etchant seeps into the interface between the upper passage layer 33 and the lower passage layer 32, separating the upper passage layer 33 from the lower passage layer 32. The inkjet head 1 cannot be manufactured in a stable manner. In contrast, if the base layer is removed in Ar dry etching, this manufacturing-related instability does not occur. The inkjet head 1 can be manufactured well.

Next, a liquid passage layer 34 is formed to a thickness of 0.5 to 5 μm by depositing a photoresist on the lower passage layer 32 and patterning it through exposure and development. See FIG. 5(c).

A base layer 35 for the upper passage layer 33 is vapor deposited all over the surface of the base layer 36 where the insulating layer 21, the lower passage layer 32, and the liquid passage layer 34 are provided on the substrate 2. See FIG. 5(d).

The base layer 35 includes an adhesive layer and a seed layer formed on the adhesive layer. The adhesive layer sits on the substrate 2, the lower passage layer 32, and the liquid passage layer 34 and is composed of metallic material, chiefly Ti or Ta. The seed layer is composed chiefly of Ni for the plating of the upper passage layer 33. The adhesive layer is 50 nm thick, and the seed layer is 50 nm thick.

The adhesive layer and the seed layer are formed continuously without leaving vacuum to maintain adhesion between the two layers. In the vapor deposition, it is preferable to introduce Ar into the vapor deposition atmosphere and form the base layer 35 under vacuum conditions at a pressure of 10⁻² Pa, in order to facilitate the base layer 35 to stick to the side faces of the liquid passage layer 34.

Alternatively, the base layer 35 may be formed by sputtering instead of vapor deposition.

Next, a resist pattern is formed by photolithography to restrict the regions on which the upper passage layer 33 will be provided. An upper passage forming layer containing Ni as the major component is provided by plating to a thickness of 2 μm on the regions of the base layer 35 which will be the upper passage layer 33. The base layer (seed layer) is removed by dry etching in Ar (sputter etching). See FIG. 5(e).

As mentioned earlier, the base layer is not completely removed, leaving the residues 37 of the base layer along the pattern of the upper passage layer 33 because of shadowing effects of the pattern of the upper passage layer 33.

The foregoing selective plating involved in the fabrication of the lower passage layer 32 and the upper passage layer 33 produces a reverse taper profile shown in FIG. 6 in the cross-section perpendicular to the length of the liquid passage sections 3. The profile allows more regions to be affected by the shadowing effects in the etching of the base layer, adding to the residues 37. FIG. 6 is a cross-sectional view of the reverse tapered liquid passage section 3.

The seed layer and the adhesive layer are each 50 nm thick. These layers are etched by very small amounts. Even if the upper passage layer 33 is used as the etching mask, the upper passage layer 33 becomes thinner only by 0.1 μm, which does not at all affect the arrangement of the inkjet head 1. Therefore, there is no need to form a separate resist pattern to etch the adhesive layer.

Next, the thermal oxide film is removed by reactive ion etching (RIE) in a reaction gas, chiefly CF₄. The upper passage layer 33 is again hardly etched by RIE in a reaction gas, chiefly CF₄. There is no need to form a separate resist pattern. Under the residues 37 there remains the thermal oxide film as part of the residues.

Steps to Fabricate Ejection Openings 51 and Etch Substrate 2

Following the steps above, the ejection openings 51 are formed on the tip of the eject section 5, and the substrate 2 is etched so that the ejection openings 51 protrude from the end face 22 of the substrate 2. These steps will be described in reference to FIGS. 7(a) to 7(d). FIGS. 7(a) to 7(d) are cross-sectional views taken along the length of the liquid passage section 3. The figures illustrate a fabrication step for the ejection opening 51 and an etching step for the substrate 2.

The tip of the pattern formed as the upper passage layer 33 and the lower passage layer 32 with respect to their lengths, in other words, the tip of the eject section 5, and the underlying insulating layer 21 are removed by Ar dry etching or CF₄ gas RIE to form the ejection opening 51. See FIG. 7(a).

In this etching to form the ejection opening 51, only the tips of the upper and lower passage layers 33, 32 are etched thanks to a photoresist pattern so formed on the upper and lower passage layers 33, 32.

The upper passage layer 33, the lower passage layer 32, and the material constituting their base layers, once etched away in the dry etching, partly re-deposit on the side faces of the photoresist pattern, and after the removal of the photoresist, remains as horn-like re-deposits 38 in proximity of the ejection opening 51.

The horn-like re-deposits 38 are sharp burrs with an apex of about 10° or smaller. It is highly likely that Taylor cones grow from the horn-like re-deposits 38. Taylor cones grow at unpredictable positions, which adds to difficult in ejecting liquid droplets in the desired direction. Supposing that there has grown a horn-like re-deposit 38, angle θ2′, which is adjacent to the apex θ2 of the horn-like re-deposit 38, is 180° or greater. See FIG. 7(b). θ2′ is an angle on an external surface of the eject section 5. θ2′ is formed inside the horn-like re-deposit 38 and the upper passage layer 33 by the external surface of the eject section 5 and a face of the horn-like re-deposit 38 which extends substantially perpendicular to the upper passage layer 33.

In the present embodiment, it is preferable if the end face of the eject section 5 where the ejection opening 51 is formed is arranged on a straight line parallel to a (110) face.

Next, the substrate 2 is diced or otherwise cut near the ejection opening 51. See FIG. 7(b). When the substrate 2 is cut, a (110) face appears in the cross-section 23. If the substrate 2 inherently shows a (110) face, the cutting step may be omitted.

Next, the cut-away end of the substrate 2 is immersed in a Si etching solution to etch the substrate 2 made of Si. See FIG. 7(c). The etching solution is a 40 wt % KOH aqueous solution heated to 80° C.

In the etching solution, the (110) face exposed in the dicing is etched quicker than the (100) and (111) faces. Therefore, the etching starts at the ejection opening 51 and progresses toward the liquid supply port 41. The part of the substrate 2 supporting the eject section 5 is removed. As a result, the eject section 5 partly protrudes beyond the end face 22 of the substrate 2.

The etching has very high reproducibility. The protrusion of the eject section 5 can be made to a desired length by managing etch time.

The (100) face, a surface of the substrate 2, is also etched. When the (111) face is exposed with the pattern edge of the lower passage layer 32 as the reference point, the etch rate decreases to almost 1/500, virtually coming to a halt.

The etching of the surface of the substrate 2 progresses to the position where the (111) face is exposed with the pattern edge of the lower passage layer 32 as the reference point in this manner. As a result, the liquid passage section 3 is disposed on a trapezoid shape as shown in FIG. 2.

The pattern edge is an edge in contact with a face of the substrate 2 which is parallel to the (110) direction of the part of the liquid passage section 3 where it has the largest width, that is, the supply section 4, in other words, the direction from the ejection opening 51 to the supply section 4.

Next, the resist (liquid passage layer 34) is removed using acetone or another solvent dissolving the resist or a resist delamination solution (e.g., delamination solution 106 manufactured by Tokyo Ohka Kogyo Co., Ltd.), to form an empty space inside the liquid passage section 3. See FIG. 7(d).

As described in the foregoing, the passage in the liquid passage section 3 of the present embodiment is formed by stacking, on the surface of the substrate 2, the insulating layer 21, the base layer 36, the lower passage layer 32, the liquid passage layer 34, the base layer 35, and the upper passage layer 33 and removing the liquid passage layer 34. This facilitates the fabrication of the passage and allows for greater freedom in passage design.

Steps to Remove Residues 37 and Horn-like Re-Deposits 38

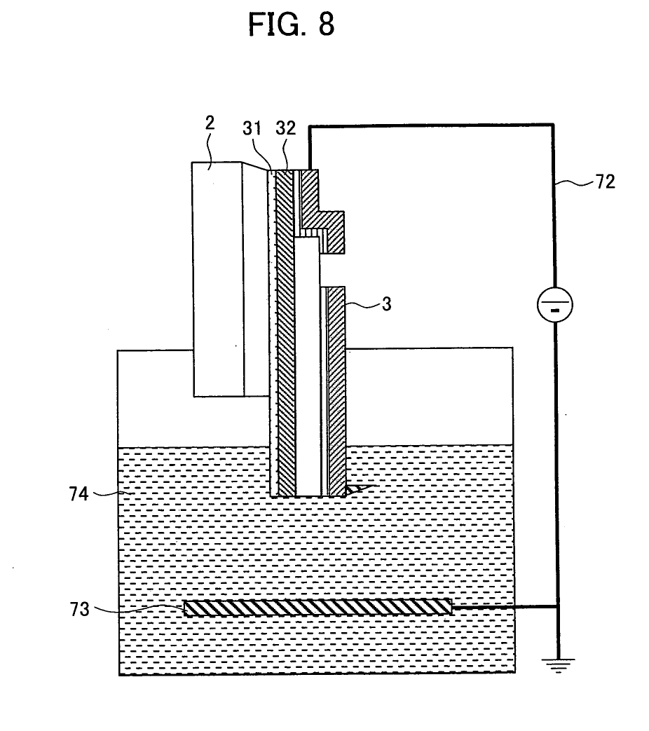

Following these steps, the residues 37 and the horn-like re-deposit 38 are removed from the eject section 5. FIG. 8 is a schematic illustration illustrating a method of electrolysis etching.

As shown in FIG. 8, the liquid passage section 3 is connected to a current conducting section 72. The liquid passage section 3 is lowered into an electrolyte solution 74 to face an opposite electrode 73. With the opposite electrode 73 being grounded, a positive electric potential is applied to the liquid passage section 3 to etch the residues 37 and the horn-like re-deposit 38 for 3 minutes.

The electrolyte solution 74 may be an aqueous solution of sulfamic acid, a mixture of chromic acid and phosphoric acid, or an aqueous solution of oxalic acid at room temperature. The opposite electrode 73 may be, for example, a Ni plate. The potential difference is 1.8 V or greater.

The etch time is supposedly three minutes; the etch time may however be altered to a suitable value while observing the residues 37 and the horn-like re-deposit 38 being removed.

Application of large voltage results in etching of the eject section 5 per se, as well as the residues 37 and the horn-like re-deposit 38. The eject section 5 is likely be deformed. Thus, the voltage preferably is set to such a value that the residues 37 and the horn-like re-deposit 38 are removed, but the eject section 5 per se is not etched.

Advantages of Electrolysis Etching

In the electrolysis etching, the electric field in the electrolyte solution is selectively concentrated at the tip of the burrs, if any. The residues 37 of metal film around the eject section 5, the horn-like re-deposit 38, and other like fine burrs are selectively and readily removed by suitable setting of the composition of the electrolyte solution and the application voltage.

Furthermore, even if the liquid passage section 3 has a reverse taper profile as shown in FIG. 6, and the residues 37 are located where shadowing takes effect in the reverse tapered profile, etching progresses by the principles above. The residues 37 can therefore be etched/removed well.

Burr Removal by Plasma Etching

Meanwhile, burrs shaped like the residues 37 are formed from the thermal oxide film which insulates the liquid passage section 3 from the substrate 2 at the joint surface between the base layer 36 and the substrate 2. The burrs are formed by the transfer of the shape of the residues 37 onto the thermal oxide film in the dry etching. These burrs are insulators and cannot be effectively removed by electrolysis etching as above. Accordingly, the burrs formed from the thermal oxide film are removed in a fluorine-involving plasma.

It is desirable if the fluorine-involving plasma etching is performed in a cylindrical plasma ashing device or other isotropic plasma processing device by introducing a reaction gas containing fluorine gas into the device.

The thermal oxide film is selectively etched, because Ni and other metallic materials are slowly etched in a fluorine-involving plasma whereas silicon oxide and nitride, like the thermal silicon oxide film, are swiftly etched.

Of the liquid passage section 3, it is the outer circumference of the eject section 5 which protrudes beyond the end face 22 of the substrate 2 that is etched. Therefore, it is desirable to use a cylindrical plasma processing device which is capable of isotropic processing in a fluorine-involving plasma.

In the plasma processing, the burrs of the thermal oxide film can be more effectively etched if the liquid passage section 3, an etching target, is negatively biased relative to ground. Since the thermal oxide film is an insulator, the liquid passage section 3 is desirably biased by RF.

Steps to Attach Manifold 6

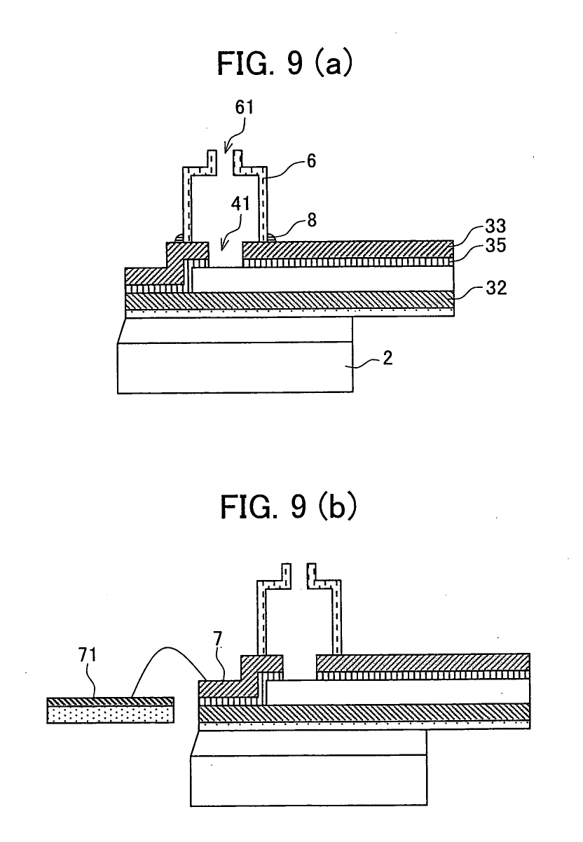

Next, as shown in FIG. 9(a), the manifold 6 is attached to the supply section 4 using an adhesion agent 8. FIG. 9(a) is a cross-sectional view illustrating an attaching steps for the manifold 6.

The manifold 6 is attached so that the opening of the fluid supply hole 61 inside the manifold 6 matches the liquid supply port 41 of the supply section 4 of the liquid passage section 3.

The manifold 6 is attached using an epoxy-based adhesion agent 8. Care is taken so that the adhesion agent 8 and the manifold 6 do not touch the circuit section 7 located at the back end of the inkjet head 1 (the end of the inkjet head 1 opposite the ejection opening 51).

As mentioned earlier, the inkjet head 1 is formed on the substrate 2. The substrate 2 has no fine structures on its back surface (the surface of the substrate 2 opposite the one on which the inkjet 1 is located). This construction allows adsorption of the substrate 2 on its back surface, to readily fix the inkjet head 1 in the attaching steps of the manifold 6. The manifold 6 to the liquid passage section 3 is securely attached.

Steps to Attach Circuit Sections 7

Next, as shown in FIG. 9(b), external wiring 71 is electrically connected to the circuit section 7 by wire bonding or other bonding technology. The wiring 71 is, for example, a flexible substrate connected to an external eject signal generating device (not shown). FIG. 9(b) is a cross-sectional view illustrating an attaching steps for the circuit section 7.

Steps of Manufacturing Manifold

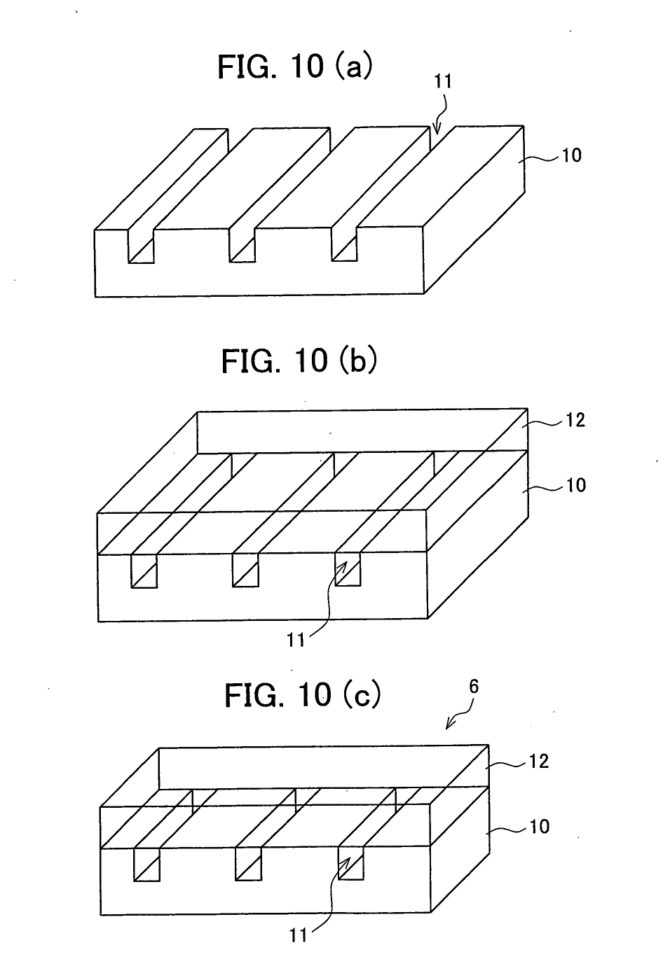

Next, a manufacturing method for the manifold 6 will be described in reference to FIGS. 10(a) to 10(c).

FIG. 10(a) to FIG. 10(c) are perspective views illustrating manufacturing steps for the manifold 6.

First, a glass or other base member 10 is diced or otherwise machined to form grooves 11 measuring 60 μm in width and 60 μm in depth. See FIG. 10(a).

The width of the grooves 11 is preferably controlled through the thickness of the blade used in dicing. Its depth is preferably controlled through how much the blade sinks into the base member. The intervals of the grooves 11 preferably match those of the liquid supply ports 41 to which the grooves 11 will be connected.

The base member 10, now having the grooves 11, is joined with a flat glass substrate 12 using an epoxy-based adhesion agent. The substrate 12 is yet to be subjected to a groove forming process. See FIG. 10(b).

The base member 10 together with the glass substrate 12 is cut into predetermined lengths by dicing at right angles to the length of the grooves 11. See FIG. 10(c).

The manifold 6 thus manufactured is attached to the liquid passage sections 3 in the attaching step above.

As described in the foregoing, the inkjet head 1 of the present embodiment can be manufactured in a stable manner.

Variation of Tip Shape of Eject Section 5—an Example

In the inkjet head 1 above, the tip-end face of the eject section 5 where the ejection opening 51 is provided (the face through which liquid is ejected) is substantially perpendicular to the length of the liquid passage section 3. The tip-end face of the eject section 5 is however not limited to such a shape.

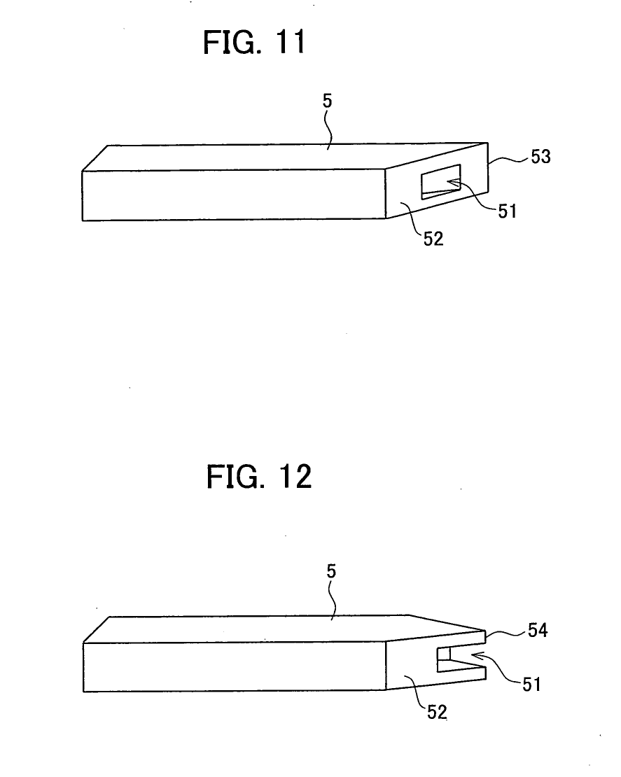

For example, as shown in FIG. 11, the tip-end face 52 of the eject section 5 may be formed oblique to the length of the liquid passage section 3 so that one of the side faces of the eject section 5 protrudes beyond the end face 22 farther than the other side face. FIG. 11 is a perspective view of another shape of the eject section 5 of the inkjet head 1 of the present embodiment. The side face of the eject section 5 refers to either of the faces that are substantially perpendicular to the surface of the substrate 2 where the liquid passage sections 3 are provided and that extend along the length of the eject section 5.

With this particular structure, the electric field near the ejection opening 51 has concentration on a front edge 53 of the tip-end face 52 where it meets one of the side faces of the eject section 5 that protrudes farther beyond the end face 22 of the substrate 2. The ink ejected at the print target object flies off the front edge 53.

Liquid droplets fly off a fixed position, i.e., the front edge 53, making the eject direction consistent. This in turn improves accuracy in delivering the ink to the print target object, hence the resolution of the printed patterns.

Alternatively, as shown in FIG. 12, the side faces of the eject section 5 at the tip tilt with respect to the length of the liquid passage section 3 so as to form a front edge 54 substantially in the middle of the tip of the eject section 5. FIG. 12 is a perspective view of another shape of the eject section 5 of the inkjet head 1 of the present embodiment.

With the tip of the eject section 5 thus shaped, the electric field near the tip of the ejection opening 51 has concentration on the front edge 54. The liquid droplets ejected at the print target object fly off the tip of the front edge 54. The liquid droplets fly off a fixed position. This in turn improves accuracy in delivering the liquid droplets to the print target object, hence the resolution of the printed patterns.

Method of Producing Tip Shape of Eject Section 5

Next, two fabrication methods will be described for the eject sections 5 with the differently shaped front-end faces discussed above.

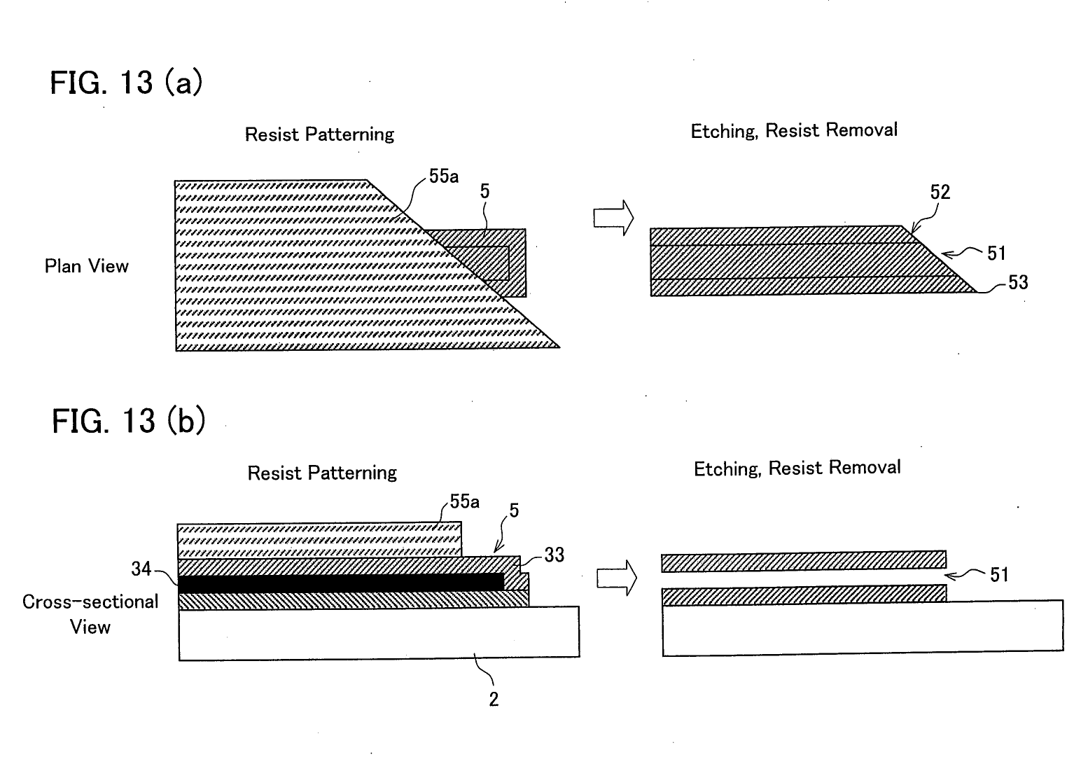

First, a fabrication method for an eject section 5 with the front edge 53 will be described in reference to FIGS. 13(a) and 13(b). FIGS. 13(a) and 13(b) show processing steps for an ejection opening 51 with the front edge 53. FIG. 13(a) is a plan view of the eject section 5. FIG. 13(b) is a cross-sectional view along the length of the eject section 5.

The tip-end face 52 of the eject section 5 with the front edge 53 is etched as follows.

First, a resist pattern 55a is formed as shown in FIGS. 13(a). The pattern 55a has side faces tilting with respect to the length of the eject section 5.

As shown in FIG. 13(a), of the side faces of the resist pattern 55a which are substantially parallel to the side faces of the eject section 5, one is longer than the other. In addition, the resist pattern 55a is formed on the upper passage layer 33 as shown in FIG. 13(b).

Next, the tip-end face 52 of the eject section 5 is etched in accordance with the resist pattern 55a by dry etching, wet etching, or another etching technique. To process the pattern with high accuracy, anisotropic high dry etching is preferred.

The tip-end face 52 of the eject section 5 etched in accordance with the resist pattern 55a in this manner is oblique to the length of the eject section 5 as shown in FIG. 13(a).

Thereafter, similarly to the earlier processing steps, the liquid passage layer 34 is removed, and the residues 37 and the horn-like re-deposit 38 are removed. Specifically, the horn-like re-deposit 38 forms over the tip-end face 52 in the etching of the tip-end face 52. The residues 37 are leftovers from the etching of the base layers for the upper passage layer 33 and the lower passage layer 32. These re-deposit 38 and residues 37 are removed by electrolytic etching. The residues of the thermal oxide film which insulates the liquid passage layer from the silicon substrate are removed in a fluorine-involving plasma.

The removal renders all the internal angles of the cross-section perpendicular to the length of the eject section 5 substantially equal to 90°, and makes the tip of the eject section 5 free from horn-like re-deposits. Non-uniform Taylor cone occurrences are limited. High quality prints become possible with high ink deliver accuracy.

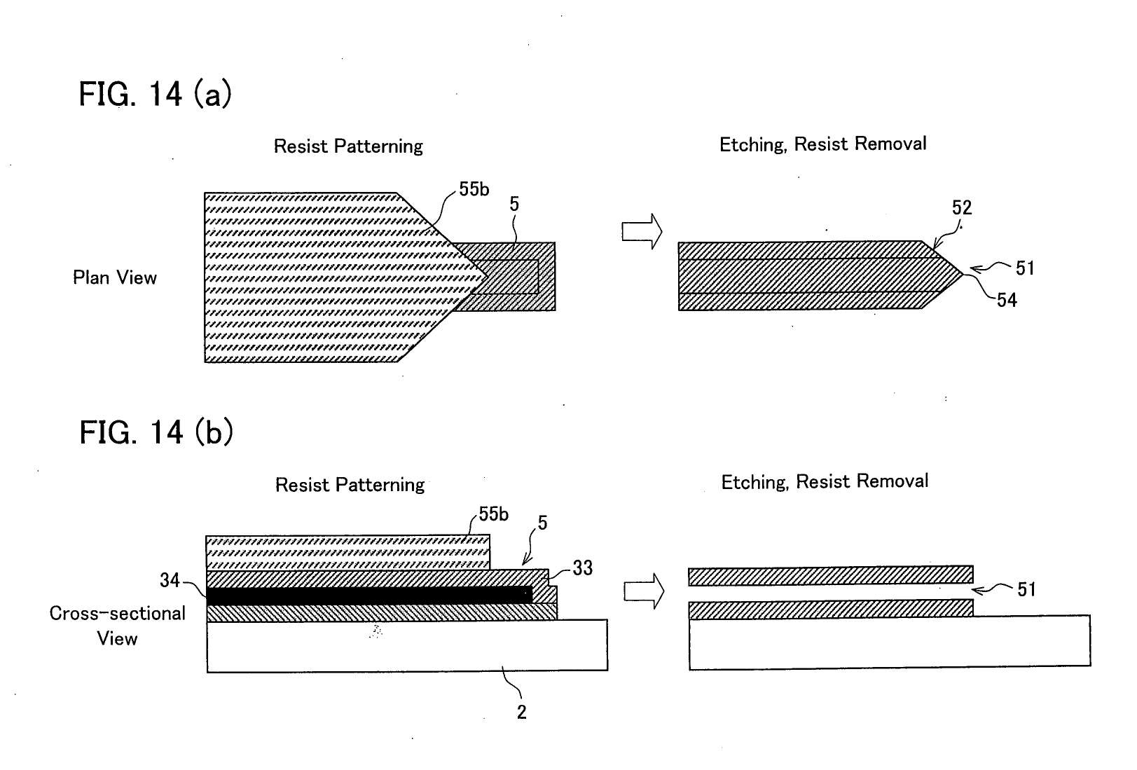

Next, a fabrication method for an eject section 5 with the front edge 54 will be described in reference to FIGS. 14(a) and 14(b). FIGS. 14(a) and 14(b) show resist patterning in processing steps for an eject section 5 with the front edge 54. FIG. 14(a) is a plan view of the eject section 5. FIG. 14(b) is a cross-sectional view along the length of the eject section 5.

The tip-end face 52 of the eject section 5 with the front edge 54 is etched as follows.

First, a resist pattern 55b is formed as shown in FIGS. 14(a) and 14(b). The pattern 55b has side faces tilting with respect to the length of the eject section 5. As shown in FIG. 14(a), the side faces of the resist pattern 55b tilt with respect to the length of the eject section 5 and toward the substantial middle of the eject section 5. The resist pattern 55b is formed on the upper passage layer 33 as shown in FIG. 14(b).

Next, the tip-end face 52 of the eject section 5 is etched in accordance with the resist pattern 55b similarly to the etching in the fabrication steps of the eject section 5 with the front edge 53.

The tip-end face 52 of the eject section 5 etched in accordance with the resist pattern 55b in this manner is has a wedge-like shape as shown in FIG. 14(a) with the side faces of the eject sections tilting with respect to the length of the eject section 5 and toward the middle of the eject section 5.

Thereafter, the liquid passage layer 34 is removed similarly to the processing steps discussed above. After that, the residues 37 and the horn-like re-deposit 38 are removed. Specifically, the horn-like re-deposit 38 forms over the tip-end face 52 in the etching of the tip-end face 52. The residues 37 are leftovers from the etching of the base layers for the upper passage layer 33 and the lower passage layer 32. These re-deposit 38 and the residues 37 are removed by electrolytic etching. The residues of the thermal oxide film which insulates the liquid passage layer from the silicon substrate are removed in a fluorine-involving plasma.

The removal renders all the internal angles of the cross-section perpendicular to the length of the eject section 5 substantially equal to 90°, and makes the tip of the eject section 5 free from horn-like re-deposits. Non-uniform Taylor cone occurrences are limited. High quality prints become possible with high ink deliver accuracy.

As discussed above, an inkjet head capable of ejecting liquid droplets in a stable direction can be made by forming the front edge 53 or the front edge 54 on the tip of the eject section 5 and removing the residues and horn-like re-deposit which are byproducts of the edge formation.

Effects

As described in the foregoing, an inkjet head with no unwanted burrs can be manufactured by removing burrs (residues, horn-like re-deposits) which are unwanted byproducts in the manufacture of the inkjet head 1 by electrolysis etching and plasma etching in the manufacturing steps of the inkjet head 1 of the present embodiment.

The nozzles of the inkjet head 1 therefore have almost no sharp burrs, such as residues or horn-like re-deposits, at their tips. Taylor cones are unlikely to grow from the burrs as growing points, which facilitates precise control of the flying direction of ink. Resultant prints show improved quality.

In the inkjet head 1, as mentioned earlier, the substrate 2 has no fine structures on its back surface (the surface opposite the one on which the liquid passage section 3 is formed). The inkjet head 1 can be fixed in a simple manner.

Pressure can be applied to couple the circuit section from the top side of the substrate 2 (the surface on which the liquid passage section 3 is formed) in the step of mounting the liquid passage section 3. The reliability of the circuit section 7 is improved.

Variation—an Example

In the above description, the latter half of the manufacturing process for the inkjet head 1 involved, listed in order of time, substrate etching, liquid passage layer removal, electrolysis etching, manifold adhesion, and bonding.

The order may be changed. Some of alternative orders are (again listed in order of time):

Liquid passage layer removal, substrate etching, electrolysis etching (involving fluorine plasma), manifold adhesion, and bonding.

Liquid passage layer removal, substrate etching, manifold adhesion, bonding, electrolysis etching.

Liquid passage layer removal, substrate etching, bonding, manifold adhesion, electrolysis etching.

Liquid passage layer removal, substrate etching, bonding, electrolysis etching, manifold adhesion.

Substrate etching, liquid passage layer removal, manifold adhesion, bonding, electrolysis etching.

Substrate etching, liquid passage layer removal, bonding, manifold adhesion, electrolysis etching.

Substrate etching, liquid passage layer removal, bonding, electrolysis etching, manifold adhesion.

In the description above, the nozzle tip, that is, the tip-end face of the eject section 5 is processed by etching. It is also possible to process by machining, such as dicing or polishing. machining.

In machining, however, processed parts are distorted under shearing force, plastically deformed parallel to the shearing force. The deformation can result in sharp edged burrs being formed on the processed parts. These burrs have similar shapes as the horn-like re-deposits discussed above. Taylor cones grow from the burrs just as they do from residues and horn-like re-deposits. The flying direction of liquid droplets become unstable.

The burrs can be however effectively removed by the electrolysis etching and isotropic etching involving a fluorine plasma of the present invention. The internal angles of the cross-section perpendicular to the length of the nozzle of the liquid passage layer are never smaller than 20°. Non-uniform Taylor cone occurrences are limited. An inkjet head nozzle is realized which provides high ink deliver accuracy and high quality prints.

The eject section 5 of the liquid passage section 3 has been described to extend 50 μm or more beyond the end face 22 of the substrate 2. This protrusion is however by no means limited. The length of the protrusion may be determined considering the ejection stability of ink, the structural stability of the eject section 5, and the magnitude of the voltage supply which causes concentration of an electric field near the ejection opening 51.

In the liquid passage section 3, the lower passage layer 32 and the upper passage layer 33 have been described to be substantially flush at the tip of the eject section 5. Either one of the lower passage layer 32 and the upper passage layer 33 may be longer than the other in the ejection direction.

The upper passage layer 33 and the lower passage layer 32 have been described as made primarily of Ni. The upper passage layer 33 and the lower passage layer 32 may however be any electrically conductive material. The layers may be made primarily of an electrically conductive material other than Ni. Examples of such a conductive material include Au and Cr.

The dimensions of the members described above give mere examples and may be changed.

The inkjet head of the present invention be an inkjet head receiving a liquid and ejecting the liquid at a print target object in response to voltage application, the head including: a substrate; and a crust stacked on the substrate to provide a liquid passage section on top of the substrate, wherein: the liquid passage section is made of the crust including a lower passage layer formed on top of the substrate and an upper passage layer formed on the lower passage layer; and the liquid passage sections includes an eject section, formed on an end face of the crust, with an ejection opening through which the liquid is ejected.

It is preferable if at least a part of a tip of the eject section is tilted with respect to a face of the eject section perpendicular to the length thereof.

It is preferable if at least one of the upper passage layer and the lower passage layer making up the crust is made of metal.

The method of manufacturing an inkjet head of the present invention may include the steps of: (a) forming a crust making up a liquid passage section on a substrate; (b) forming an ejection opening at an end of the crust; (c) removing a part of the substrate under the end of the crust which has the ejection opening; and (d) etching an outer circumference near at least the ejection opening of the crust.

It is preferable if in step (d), the crust and an opposite electrode electrically connected to the crust are immersed in an electrolyte solution; and a potential difference is developed between the crust and the opposite electrode.

It is preferable if in step (d), a fluorine-involving plasma is used.

As detailed above, in the inkjet head of the present invention, it is preferable if the internal angles are greater than 20° at least 10 μm from a tip of the eject section.

Concentration of an electric field at the tip (ejection opening) of the eject section causes a liquid droplet to fly from the ejection opening. The electric field concentrated at the tip of the eject section in practice affects about 10 μm from the tip. It is therefore preferable if there are no unwanted burrs up to about 10 μm from the tip.

According to the arrangement, the internal angles formed by the external surfaces of the eject section are greater than 20° at least about 10 μm from the tip of the eject section, which indicates that there are no unwanted burrs formed on that part of the eject section.

The absence reduces the possibility of Taylor cones occurring around unwanted burrs. Liquid droplets fly in a consistent direction.

It is preferable if the cross-section perpendicular to the direction is smaller near the ejection opening than away from the ejection opening.

According to the arrangement, the cross-section perpendicular to the direction in which the eject section, which forms the ejection opening, protrudes is smaller near the ejection opening than away from the ejection opening. In other words, the eject section narrows down toward the tip.

The narrowing down shape allows an electric field to be effectively concentrated at the tip of eject section. It becomes easier to form Taylor cones at the tip.

Therefore, the eject section ejects liquid droplets in a more effectively controlled direction. The locations of delivery of liquid droplets can be set out with high accuracy.

It is preferable if: the hollow section includes a plurality of layers stacked on the substrate; and at least some of the layers are composed of an electrically conductive material.

According to the arrangement, the hollow section is formed by stacking a plurality of layers on the substrate.

The hollow structure is readily fabricated by stacking the plurality of layers so as to encase a removable one of the layers in hardly removable layers and thereafter removing the removable layer.

Furthermore, in the hollow section, there is disposed an electrically conducting layer extending from the substrate to the ejection opening. Electric charges, when supplied from the substrate to the ejection opening, meet less electrical resistance.

The result is quick charging of the liquid to be ejected, hence better response in ejection. Liquid droplets are therefore ejected at high speed.

It is preferable if in step (c): the hollow section and an opposite electrode electrically connected to the hollow section are immersed in an electrolyte solution; and a potential difference is developed between the hollow section and the opposite electrode.

In this etch process, an electric field is concentrated around a sharp burr composed of electrically conductive material. Therefore, the sharp burr is etched before other parts. If the burr formed on an external surface of the protruding hollow section has a sharp edge and is composed of electrically conductive material, the burr is etched before other parts.

Therefore, the arrangement efficiently removes sharp-edged, electrically conductive burrs which are formed on an external surface of the protruding hollow section.

Furthermore, etching conditions can be controlled easily by control voltage applied to the hollow section and the opposite electrode. The burrs are therefore removed under suitable conditions.

It is preferable if in step (c), a fluorine-involving plasma is used.

Si compounds such as SiO2 film can be etched well by a fluorine-involving plasma. If there is a Si compound burr on an external surface of the eject section, the burr is etched before other parts.

Therefore, the arrangement efficiently removes Si compound burrs formed on the external surfaces of the protruding hollow section.

The inkjet head of the present invention can be formed on a surface of the substrate. Freedom increases in design where the shape of the liquid passage section or the liquid flow passage can be changed more freely. The inkjet head of the present invention can eject ink in a particular direction in a stable manner. Therefore, the invention is applicable to various inkjet heads needed in accordance with the properties of the ejected liquid and the print target object at which the liquid is ejected.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. An inkjet head receiving a liquid and ejecting the liquid at a print target object in response to voltage application, said head comprising:
a substrate; and
a hollow section formed on a surface of the substrate to provide a passage for the liquid, wherein:
the hollow section includes an eject section with an ejection opening through which the liquid is ejected;
at least a part of the eject section, which forms the ejection opening, protrudes from an end of the substrate; and
of internal angles of a cross-section substantially perpendicular to a direction in which the eject section protrudes or a cross-section substantially parallel to the direction, all those internal angles which are formed by external surfaces of the eject section are greater than 20°.

2. The inkjet head of claim 1, wherein the internal angles are greater than 20° at least 10 μm from a tip of the eject section.

3. The inkjet head of claim 1, wherein the cross-section perpendicular to the direction is smaller near the ejection opening than away from the ejection opening.

4. The inkjet head of claim 1, wherein:
the hollow section includes layers stacked on the substrate; and
at least some of the layers are composed of an electrically conductive material.

5. A method manufacturing an inkjet head receiving a liquid and ejecting the liquid at a print target object in response to voltage application, said method comprising the steps of:
(a) fabricating a hollow section formed on a surface of a substrate to provide a passage for the liquid, the hollow section including an eject section with an ejection opening through which the liquid is ejected;
(b) etching an end of the substrate so that at least a part of the eject section protrudes from the end; and
(c) etching away a burr on an external surface of the eject section to remove the burr.

6. The method of claim 5, wherein in step (c):
the hollow section and an opposite electrode electrically connected to the hollow section are immersed in an electrolyte solution; and
a potential difference is developed between the hollow section and the opposite electrode.

7. The method of claim 5, wherein in step (c), a fluorine-involving plasma is used.
